(19) United States
(12) Patent Application Publication
(10) Pub. No.: US 2013/0112227 A1
(43) Pub. Date: May 9, 2013

(54) Elimination of hydraulic fluid contamination through internal bright annealing

(71) Applicants: Terry R. Bussear, Spring, TX (US); William M. Bailey, Humble, TX (US)

(72) Inventors: Terry R. Bussear, Spring, TX (US); William M. Bailey, Humble, TX (US)

(73) Assignee: Baker Hughes Incorporated, Houston, TX (US)

(21) Appl. No.: 13/290,522

(22) Filed: Nov. 7, 2011

(51) Int. Cl. B08B 9/032; B08B 5/00; B08B 7/04

(52) U.S. Cl. 134/19; 134/105

(57) ABSTRACT

A method and apparatus for cleaning a tubular member is disclosed. A storage device holds the tubular member in a finished form and a translation device passes the tubular member from the first storage device. A gas is supplied through the tubular member. A heating device heats the drawn tubular member and the gas passing through the tubular member to clean debris from inside the tubular member.

### BACKGROUND OF THE DISCLOSURE

1. Field of the Disclosure

The present disclosure relates to methods and apparatus for reducing contaminations in tubular parts, such as in petroleum exploration and production.

2. Description of the Related Art

Various systems in oil exploration and production use hydraulic tubes that extend from a first location, typically a surface location, to a second downhole location. The hydraulic tubes include fluids that transfer hydraulic forces from the first location to the second location. Typically, these tubes are procured in their finished form and contain a certain amount of debris on the interior of the tubes that are remnants from the production process that formed the tubes. When the tubes are put into use, this debris tends to accumulate at the bottom of the tube and hinder the ability of the hydraulic fluid in the tubes to transfer forces. Therefore, there is a need to provide hydraulic tubes that are free from debris. The present disclosure provides an apparatus and a method of cleaning the interior of such tubes.

### SUMMARY OF THE DISCLOSURE

In one aspect, the present disclosure provides a method of cleaning debris from inside a tubular member, including: passing the tubular member from a first storage device in a finished form through a heating region; supplying a first gas through the member; and heating the member and the first gas at the heating region to clean the debris from inside the tubular member.

In another aspect, the present disclosure provides an apparatus for cleaning a tubular member that in a particular embodiment including a first storage device configured to hold the tubular member in a finished form; a translation device configured to draw the tubular member from the storage device in the finished form; a pump configured to pump a gas through the tubular member; and a heating device configured to heat the drawn tubular member and the gas to clean the tubular member.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 shows an exemplary embodiment of an apparatus for cleaning a tubular member in one embodiment of the present disclosure;

FIG. 2 shows an embodiment of another apparatus of the present disclosure for cleaning an exemplary tubular member;

FIG. 3 shows an apparatus for annealing and quenching an exemplary tubular member to clean the tubular member in another embodiment of the present disclosure; and

FIG. 4 shows an exemplary apparatus for preparing the tubular member for the cleaning methods of the present disclosure.

### DETAILED DESCRIPTION OF THE DISCLOSURE

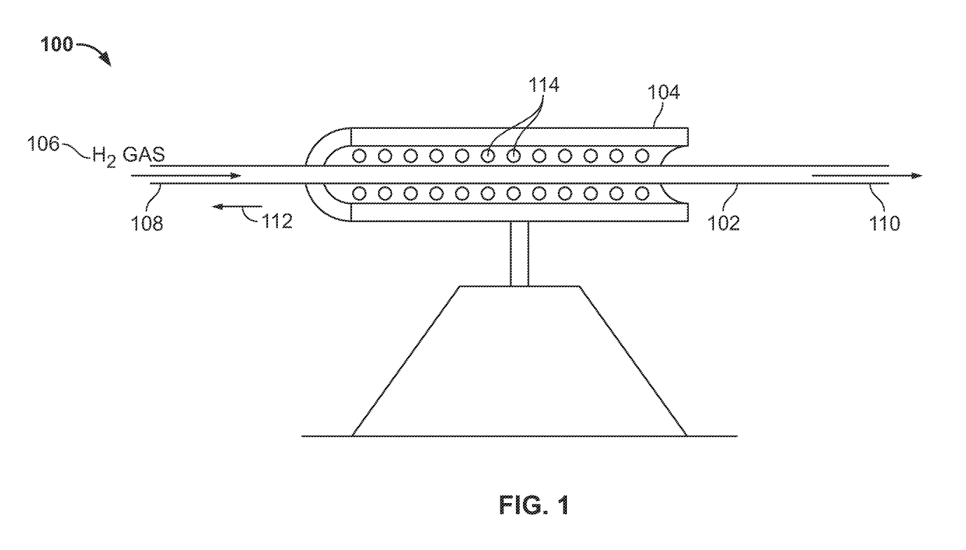

FIG. 1 shows an exemplary apparatus 100 for cleaning a tubular member 102 using bright annealing according to one embodiment of the disclosure. Typically, the tubular member is made of an alloy that includes at least one of Nickel (Ni), Chromium (Cr), Iron (Fe) and Molybdenum (Mo), such as Ni/Cr/Mo alloys, Ni/Fe/Mo alloys, Fe/Cr/Ni/Mo alloys or Ni/Fe/Cr/Mo alloys, for example. Various exemplary compositions of the member include carbon steel, 316 stainless steel, 825 nickel alloy and 625 nickel alloy. In one embodiment, the tubular member is a capillary tube usable as a hydraulic fluid line extending from a surface location to a downhole location in various petroleum exploration and production systems. A tubular member (also referred to herein as “tube” or “member”) generally refers to a hollow elongated body, which is typically, but not necessarily, cylindrical. The tubular member is generally stored at a first storage device prior to the cleaning processes described herein and after completion of a production process. Thus, the tubular member is stored on the first storage device in a finished form. A tubular member in finished form refers to the tubular member being in a shape such that it can be used for its intended purposes upon being drawn from the first storage device without further shaping, molding, fashioning or forging. Typically, such finished tubes include debris on an inner surface of the tubes as a remnant of the production process. In a typical cleaning process, the tubular member 102 is drawn through a heating region defined by heating device 104 along an axial direction (i.e., the elongated direction) of the member such as indicated by exemplary direction arrow 112. A translation device (not shown) can be used to draw the member through the heating device. An endothermic gas 106 is pumped through an interior of the tubular member 102. The endothermic gas is pumped into the member at inlet 108 and exits the member at outlet 110. Therefore, the endothermic gas is pumped through the tubular member in a direction (i.e., left to right in FIG. 1) that is opposite the drawing direction 112 of the tubular member (i.e., right to left in FIG. 1). In the exemplary embodiment of FIG. 1, the heating device 104 is a clam shell cavity which, in one embodiment, is open to air in the surrounding environment. The heating device 104 includes one or more heating elements 114 which heat the tubular member 102 substantially at or above a suitable annealing temperature. In various embodiments, this annealing temperature is about 2000° F. The annealing process occurs in the presence of the endothermic gas in the interior of the tubular member in order to clean debris from the inner surface of the tubular member. During the annealing process, the endothermic gas 106 binds with oxides on the inner surface of the member to remove an oxide film from the inner surface. Any debris residing on the film is therefore also removed and carried out of the tube via the pumped gas, thereby leaving a clean inner surface of the tubular member.

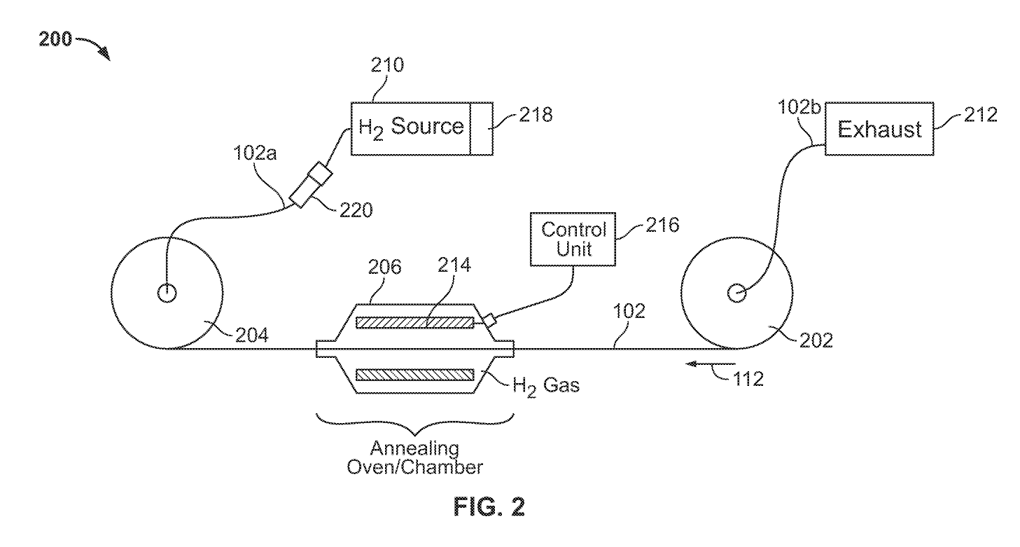

FIG. 2 shows another embodiment of another apparatus 200 of the present disclosure for cleaning an exemplary tubular member. Tubular member 102 is shown being unwound from a first storage device (first spool 202) and being wound onto a second storage device (second spool 204). In one aspect, the second spool 204 rotates about an axis to draw of the tubular member from the first spool 202. The tubular member therefore moves in direction indicated by arrow 112 between the spools. The tubular member may be a seamless member or may be a welded tubular member made from a strip of sheet material that is longitudinally welded for the full length of the tubular member. The tubular member may be a single continuous member or may include two or more tubular members coupled to each other via a weld, for example, a butt weld. Welds are generally regions of high oxidization. Gas source unit 210 is coupled to an inlet 102a of the member at the second spool 204 via coupling device 220. The gas source unit 210 may include a pump 218 for pumping the gas from the gas source unit 210 at a selected rate. Gas is pumped through the tubular member 102, entering at inlet 102a and exiting at outlet 102b as an exhaust gas. In one embodiment, the gas is an endothermic gas, such as hydrogen (H₂). In one embodiment, the outlet 102b can deliver the exhaust gas to an ambient atmosphere. In an alternate embodiment, the outlet 102b is coupled to an exhaust chamber 212 for storing the exhaust gas and debris. An oven or heating device 206 is disposed between the first spool 202 and the second spool 204 such that the tubular member 102 is drawn through the oven 206 as it travels between spools. The oven 206 includes a first opening to allow the member to enter the oven and a second opening to allow the member to exit the oven. Oven 206 includes one or more heating elements 214 that heat the member to a suitable annealing temperature. A control unit 216 may be coupled to the oven 206 to control the heating element as well as various aspects of the annealing process. In one embodiment, the environment of the oven includes ambient air. In an alternate embodiment, the oven 206 is substantially filled with a second gas, which may also be an endothermic gas, such as hydrogen, argon or an inert gas. The second gas is in contact with an outer surface of the tubular member 102 during the annealing process in order to prevent scaling (oxidation) on the outer surface of the tubular member 102.

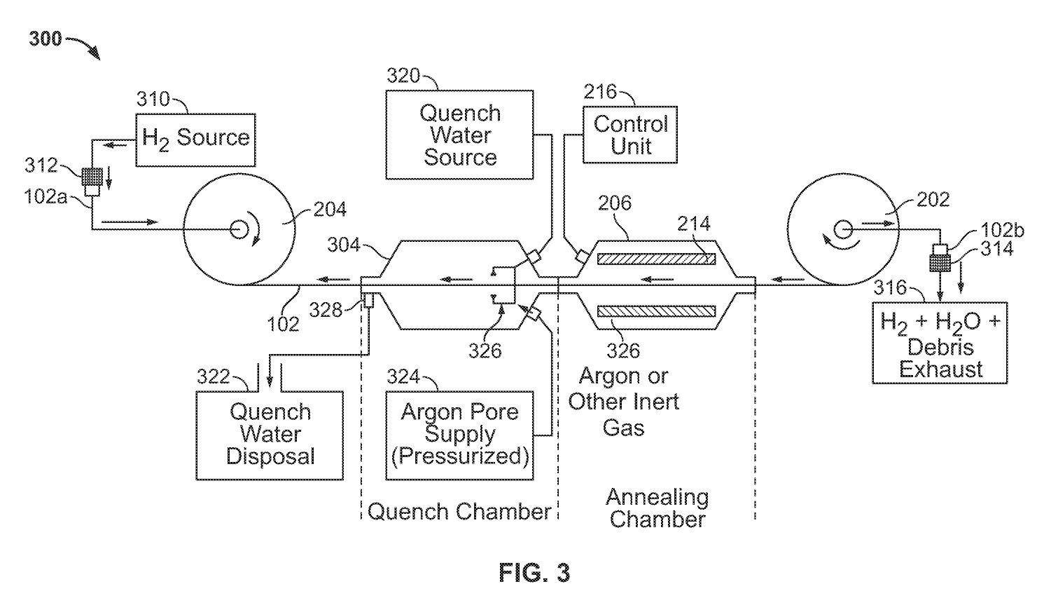

FIG. 3 shows an apparatus 300 for annealing and quenching an exemplary tubular member to clean the tubular member in another embodiment of the present disclosure. Tubular member 102 is unwound from first spool 202 and is later wound onto second spool 204. Between spools 202 and 204, the tubular member passes through an annealing chamber or oven (heating device 206) and a quench chamber 304. The oven 206 includes one or more heating elements 214 configured to provide heat for an annealing process. Control unit 216 is coupled to oven 206 and is configured to control the one or more heating elements 214 and various aspects of the annealing process. A gas source 310 is coupled to the inlet 102a of the tubular member at the second spool via coupling member 312. First endothermic gas is pumped from gas source 310 into the tubular member 102 at the inlet 102a and exits the member 102 at outlet 102b at first spool 202 as an exhaust gas. An exhaust storage unit 316 may be coupled to the outlet 102b via coupling member 314. The exhaust gas exiting the tubular member 102 is stored at the exhaust storage unit 316. In one embodiment, a second endothermic gas 326, such as H₂, Argon or another inert gas, may provide the environment of the oven to prevent scaling at the outer surface of the tubular member 102. The exemplary apparatus 300 further includes a quench chamber 304 coupled to the oven 206. In one embodiment, the tubular member passes directly from the oven 206 to the quench chamber 304. The quench chamber 304 cools the member when the member exits the oven 206. In various embodiments, the tubular member can be quenched to about 600° F. The quench chamber is coupled to a quench mediumsource 320 that supplies a quench medium to the quench chamber 304. In an exemplary embodiment, the quench medium is a liquid such as water. Spray nozzles 326 spray the quench liquid from the quench medium source 320 onto the tubular member. An outlet 328 in the quench chamber enables the quench liquid to drain from the quench chamber 304 for storage at quench medium storage unit 322. Alternatively, the quench medium may be a gas such as a purge gas discussed below. A purge gas supply 324 may be coupled to the quench chamber to supply a purge gas to the quench chamber. In an exemplary embodiment, the purge gas is argon. The purge gas enables the tubular member to cool in a substantially oxygen-free environment. The argon purge gas may therefore also be used as a quench medium. In various embodiments, the argon may be circulated between the quench chamber and a cooling unit.

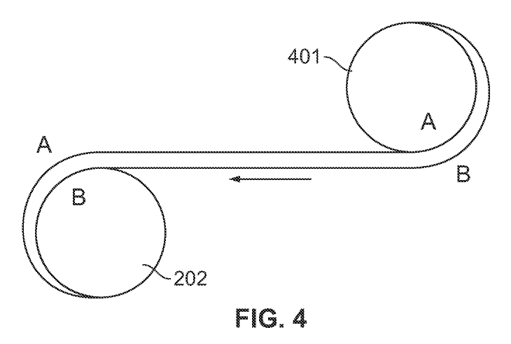

FIG. 4 shows an exemplary apparatus for preparing the tubular member on the first spool 202 prior to the methods of cleaning the tubular member described herein. The exemplary apparatus breaks debris away from the inner surface of the tubular member by transferring the tubular member from a third storage device to the first storage device. The tubular member is typically stored on at the third storage device (third spool 401) after the production of the tubular member. The tubular member curves when stored on the third spool 401 in a manner such that one side of the member (side A) is on an inner side of the curve and an opposite side of the member (side B) on the outer side of the curve. The tubular member is unwound from the spool 401 onto the spool 202 as illustrated in FIG. 4 prior to being drawn from the first spool for cleaning. As stored at spool 202, side B is on the inner side of the curve and side A is on the outer side of the curve. Thus, side A goes from a experiencing a tensile force on third spool 401 to experiencing a compressive force on first spool 202. Meanwhile, side B goes from experiencing a compressive force on third spool 401 to a tensile force on first spool 202. This change in the distribution of forces serves to detach debris that is attached from the inner surface of the tubular member, thereby facilitating the cleaning process of the present disclosure. Any other method or apparatus for detaching debris from the inner surface can also be used.

Therefore, in one aspect, the present disclosure provides a method of cleaning debris from inside a tubular member, including: passing the tubular member from a first storage device in a finished form through a heating region; supplying a first gas through the member; and heating the member and the first gas at the heating region to clean the debris from inside the tubular member. Passing the tubular member from the first storage device typically includes passing the tubular member through the heating region substantially continuously at a controlled rate. Wherein the first storage device is a spool, the method further comprises winding the tubular member on a second spool after the tubular member has passed through the heating region. In a typical embodiment, the first gas is pumped through the tubular member in a direction opposite the direction in which the tubular member is drawn. The heating region can be a clam-shell heating device or an oven in various embodiments. In one embodiment, the first gas is hydrogen. The method may further include heating a second gas at an outer surface of the tubular member, wherein the second gas is at least one of: (i) hydrogen; (ii) argon; (iii) an inert gas; and (iv) an endothermic gas. The tubular member may be quenched after being heated. Quenching the tubular member may include a least one of: (i) spraying the tubular member with a liquid; and (ii) passing a purge gas around the exterior of the tubular member. In one embodiment, bonds between the debris and the inside of the tubular member are broken before passing the tubular member through the heating region.

In another aspect, the present disclosure provides an apparatus for cleaning a tubular member, the apparatus including a first storage device configured to hold the tubular member in a finished form; a translation device configured to draw the tubular member from the first storage device in the finished form; a pump configured to pump a first gas through the tubular member; and a heating device configured to heat the drawn tubular member and the first gas to clean the tubular member. The apparatus may further include a second storage device configured to store the cleaned tubular member. In a typical embodiment, the pump is configured to pump the first gas through the tubular member in a direction opposite the direction in which the translation device draws the tubular member. In a particular embodiment, the first storage device is a spool and the tubular member is wrapped around the spool. The heating device may be a clam-shell heating element or an oven in various embodiments. In one embodiment, wherein the first gas is hydrogen. The heating device may be configured to heat a second gas at an outer surface of the tubular member, wherein the second gas is at least one of: (i) hydrogen; (ii) argon; (iii) an inert gas; and (iv) an endothermic gas. The apparatus may further include a quench chamber for cooling the tubular member exiting the heating device. The quench chamber may include at least one of: (i) a device configured to spray the tube with a liquid; and (ii) a device configured to pass a purge gas around the exterior of the tube. In one embodiment, the apparatus includes a device configured to break a bond between debris and an inside of the tubular member before the tubular member is drawn through the heating region.

While the foregoing disclosure is directed to the certain exemplary embodiments of the disclosure, various modifications will be apparent to those skilled in the art. It is intended that all variations within the scope and spirit of the appended claims be embraced by the foregoing disclosure.

1. A method of cleaning debris present inside a finished tubular member, comprising:
passing the tubular member from a storage device thereof through a heating region;
supplying a gas through the tubular member; and
heating the member and the gas at the heating region to clean the debris present inside the tubular member.

2. The method of claim 1, wherein passing the tubular member comprises passing the tubular member through the heating region substantially continuously at a controlled rate.

3. The method of claim 1, wherein the storage device is a first spool, the method further comprising winding the tubular member on a second spool after the tubular member passes through the heating region.

4. The method of claim 1, wherein supplying the gas comprises pumping the gas through the tubular member in a direction opposite the direction in which the tubular member passes through the heating region.

5. The method of claim 1, wherein the heating region comprises at least one of: (i) a clam-shell heating device; and (ii) an oven.

6. The method of claim 1, wherein the gas is hydrogen.

7. The method of claim 1 further comprising heating an outer surface of the tubular member with another gas selected from a group consisting of: (i) hydrogen; (ii) argon; (iii) an inert gas; and (iv) an endothermic gas.

8. The method of claim 1 further comprising quenching the tubular member after heating the tubular member.

9. The method of claim 8, wherein quenching the tubular member further comprises at least one of: (i) exposing the tubular member to a liquid; and (ii) passing a purge gas around an exterior of the tubular member.

10. The method of claim 1 further comprising breaking a bond of debris with inside of the tubular member before passing the tubular member through the heating region.

11. An apparatus for cleaning a tubular member, comprising:
a storage device configured to hold the tubular member in a finished form;
a translation device configured to draw the tubular member from the first storage device in the finished form;
a pump configured to pump a gas through the tubular member; and
a heating device configured to heat the drawn tubular member and the gas to clean the tubular member.

12. The apparatus of claim 11, further comprising another storage device configured to store the cleaned tubular member.

13. The apparatus of claim 11, wherein the pump is configured to pump the first gas through the tubular member in a direction opposite the direction in which the translation device draws the tubular member.

14. The apparatus of claim 11, wherein the storage device is a spool and the tubular member is wrapped around the spool.

15. The apparatus of claim 11, wherein the heating device is at least one of: (i) a clam-shell heating element; and (ii) an oven.

16. The apparatus of claim 11, wherein the gas is hydrogen.

17. The apparatus of claim 10, wherein the heating device is configured to heat an outer surface of the tubular member with another gas that is selected from a group consisting of: (i) hydrogen; (ii) argon; (iii) an inert gas; and (iv) an endothermic gas.

18. The apparatus of claim 1 further comprising a quench chamber configured to cool the tubular member exiting the heating device.

19. The apparatus of claim 18, wherein the quench chamber further comprises at least one of: (i) a device configured to spray the tubular member with a liquid; and (ii) a device configured to pass a purge gas around an exterior of the tubular member.

20. The apparatus of claim 14 further comprising a device configured to break a bond between debris and an inside of the tubular member before the tubular member is drawn through the heating region.
